(19) United States
(12) Patent Application Publication
(10) Pub. No.: US 2024/0077110 A1
(43) Pub. Date: Mar. 7, 2024

(54) BEARING UNIT HAVING A HIGH-PERFORMANCE RETENTION DEVICE

(71) Applicant: AKTIEBOLAGET SKF, Goteborg (SE)

(72) Inventor: Piero Santangelo, Torino (IT)

(21) Appl. No.: 18/384,096

(22) Filed: Oct. 26, 2023

Related U.S. Application Data
(62) Division of application No. 17/502,158, filed on Oct. 15, 2021, now Pat. No. 11,835,091.

(30) Foreign Application Priority Data
Oct. 16, 2020 (IT) 102020000024403

(51) Int. Cl. F16C 33/38; F16C 33/41

(52) U.S. Cl. CPC F16C 33/3887; F16C 33/3875; F16C 33/3881; F16C 33/41; F16C 2226/74

(57) ABSTRACT

A bearing unit includes a radially outer ring, a radially inner ring, a row of rolling bodies interposed between the radially outer ring and the radially inner ring and a cage for retaining the rolling bodies, where the cage includes a rib with a circular base and a plurality of circumferentially spaced fingers defining a plurality of pockets for holding the respective rolling bodies of the row of rolling bodies. Also, a plurality of inserts formed separately from the cage, each of the plurality of inserts being inserted inside seats of corresponding adjacent pairs of fingers of the plurality of fingers to limit circumferential deformation of the fingers.

### CROSS-REFERENCE

This application is a division of U.S. patent application Ser. No. 17/502,158, filed Oct. 15, 2021, which claims priority to Italian patent application no. 10 2020 000 024 403 filed on Oct. 16, 2020, and the contents of both applications are fully incorporated herein by reference.

### TECHNOLOGICAL FIELD

The present invention relates to a bearing unit provided with a high-performance retention device. The retention device has innovative features that allow good retention of the rolling bodies of bearing units at high speed and at high temperature and is suitable for electric motors, alternators and in general for assemblies that have a bearing unit BACKGROUND

According to the conventional art, a cage for rolling bodies, especially balls, of a bearing unit is formed from a rib with a circular base and a plurality of circumferentially spaced fingers that extend from one side of the rib. The base rib and the fingers have partially spherical concave surfaces, together defining a plurality of partially spherical pockets or cavities for retaining said balls.

Conventional cages, which may be made of a polymer material, have performance limitations both in terms of rotary speed of the bearing unit and in terms of operative working temperature. In fact, at high speeds (for example, for rotary speeds close to 20000 rev/min), owing to the centrifugal force, the fingers forming the cavities for housing the balls tend to “open up” which lessens the retention of the balls. The results are a) the cage is expelled from its seating and is destined for probable breakage, b) probable expulsion of the balls from their seats, and c) consequent loss of function of the bearing.

A similar problem arises due to high operating temperatures, or through the combined effect of high speed and high temperature. For example, in conditions with a rotary speed close to 20000 rev/min and temperatures around 150° C., the radial deformation of the cage is of such an extent that the cage will rub against the radially outer ring of the bearing unit.

To overcome this limitation, it might be possible to use special materials, for example metallic materials. However, this solution is not feasible because such materials are very expensive and the speed advantages are still limited: at high speeds, in fact the metallic material makes the cage too noisy.

There is therefore a need to design a retention device for rolling bodies (in particular, balls) of bearing units that is free from the aforementioned drawbacks. In other words it is necessary to ensure an adequate force of retention of the rolling elements in conditions of high speed and/or high operating temperatures.

### SUMMARY

The present disclosure is directed to a bearing unit provided with a retention device for the rolling bodies that is able to operate in conditions of high rotary speed and/or high temperature without a risk of loss of retention of the rolling bodies.

According to a first aspect, the retention device comprises a cage made of a polymer material and a plurality of inserts, also made of polymer material, which when coupled to the cage react to the forces acting on the fingers of the cage, thus preventing them from opening.

In a second aspect, the retention device is made in two parts and comprises a cage and an insert holder, the latter provided with a plurality of inserts integral therewith, which when coupled to the cage react to the forces acting on the fingers of the cage, preventing them from opening.

According to another aspect a bearing unit includes a radially outer ring, a radially inner ring and a cage between the radially outer ring and the radially inner ring. The cage comprises a cylindrical body having a radially inner surface, a radially outer surface, a first axial side and a second axial side, and a plurality of pockets extending axially into the first axial side. Each of the plurality of pockets extends radially through the cylindrical body and has an axial opening and a pocket bottom axially spaced from the axial opening, and each of the pockets retains a rolling body having a diameter greater than a circumferential width of the axial opening. A plurality of depressions extend axially into the first axial side of the cage between each adjacent pair of the plurality of pockets, and each of the depressions has a first side wall and a second side wall configured such that a circumferential distance between the first side wall and the second side wall decreases in a direction from the first axial side toward the second axial side. Each of the depressions includes a depression bottom having an aperture that has a circumferential width. The unit also includes at least one insert formed separately from the cage. An axially outer portion of each pocket is defined by the first axial side of the cage and an imaginary plane intersecting the bottoms of each of the depressions, and an axially inner portion of each pocket is located between the imaginary plane and the second axial side of the cage. Portions of the cage located circumferentially between the axially outer portion of each pocket and the depression form fingers configured to flex to permit one of the rolling bodies to move axially through the axial opening when the at least one insert is not located in the plurality of depressions. The at least one insert includes a first side wall in contact with the first side wall of the depression at a first joint and a second side wall in contact with the second side wall of the depression at a second joint and a projection extending through the aperture in the depression bottom. The projection includes a distal end and a neck between the distal end and the imaginary plane, and a circumferential width of the neck is less than the circumferential width of the aperture in the depression bottom. Furthermore, when the first side wall of the insert is in contact with the first side wall of the depression and the second side wall of the insert is in contact with the second side wall of the depression the at least one insert is configured to prevent the fingers from flexing to a degree that would permit the rolling body in the pocket adjacent to the at least one insert from moving axially out of the axial opening.

### BRIEF DESCRIPTION OF THE DRAWINGS

The disclosure will now be described with reference to the appended drawings, which illustrate some non-limiting embodiment examples thereof, in which:

FIG. 1 is an exploded perspective view of a bearing unit comprising a retention device provided with inserts for improving the retention of the rolling bodies according to a first embodiment.

FIG. 2 is a partial sectional perspective view of the bearing unit of FIG. 1 with the inserts in a first configuration of coupling to the retention cage.

FIG. 3 is a partial sectional perspective view of the bearing unit provided with the retention device from FIG. 1 with the inserts in a second configuration of coupling to the retention cage.

FIG. 4 is an exploded perspective view of a bearing unit comprising a retention device provided with inserts and an associated insert holder for improving the retention of the rolling bodies, in a second embodiment of the present disclosure.

FIG. 5 is a partial sectional perspective view of the bearing unit provided with the retention device of FIG. 4.

### DETAILED DESCRIPTION

Purely for purposes of illustration and not for limiting the present invention (which is defined by the appended claims), embodiments of the present invention will now be described in association with a generic bearing unit provided with the inventive retention cage.

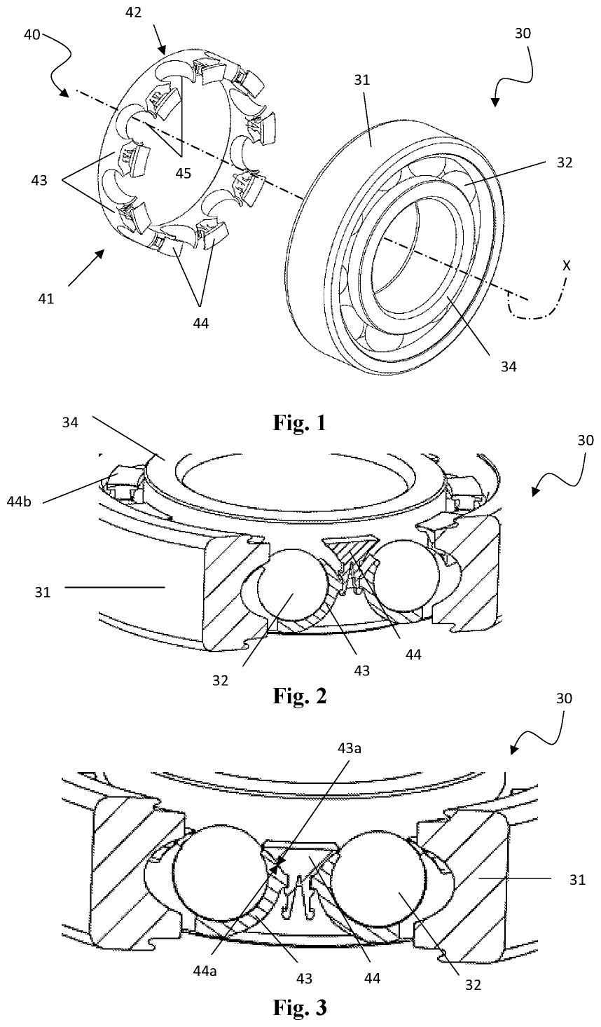

Referring to FIG. 1, the bearing unit 30 comprises a radially outer ring 31, a radially inner ring 34, a row of rolling bodies 32, in this example balls, interposed between the radially outer ring 31 and the radially inner ring 34, and a retention device 40 for keeping in position the rolling bodies 32.

Throughout the present description and in the claims, the terms and the expressions indicating positions and orientations such as “radial” and “axial” refer to the central axis of rotation X of the bearing unit 30, unless stated otherwise.

The retention device 40, according to a first embodiment of the invention, is made of polymer material and comprises: a cage 41 comprising a rib 42 with a circular base and a plurality of fingers spaced circumferentially that extend from one side of the rib 42, and a plurality of inserts 44 of prismatic shape.

The base rib 42 and the fingers 43 have partially spherical concave surfaces, together defining a plurality of pockets 45 or partially spherical cavities for retaining respective balls by means of contact zones. Therefore the cage 41 is similar to the conventional cages.

The method of mounting this retention device 40 includes the assembly of the cage 41 in the bearing unit 30. This is followed by mounting of each of the inserts 44 of the plurality of inserts in corresponding seats made in the fingers 43 of the cage 41. FIG. 2 illustrates an insert 44 in a first preassembly position. Then, referring to FIG. 3, each of the inserts 44 is then pushed inside the corresponding seat of the fingers 43 so as to reach a second, final assembly position. Preferably, the coupling system between the inserts 44 and the corresponding seats of the fingers 43 of the cage 41 consists of a snap-fitting solution, although other coupling solutions may also be envisaged.

Once coupling has been effected, each of the inserts 44 is configured for exerting a stop action against the corresponding finger 43. This stop action is effected by means of an oblique surface 44a of the insert 44 with respect to a corresponding oblique surface 43a of the finger 43 of the cage 41, the surface 44a of the insert and the surface 43a of the finger having the same inclination. More precisely, each insert of the plurality of inserts 44 comprises a pair of oblique surfaces 44a that engage with a pair of oblique surfaces 43a of corresponding fingers of the plurality of fingers 43 of the cage 41. The surfaces 44a of the insert 44 are able to absorb the stresses, typically in the radial and/or tangential direction, that the bearing unit 30 transmits to the cage 41. Therefore the fingers 43 of the cage 41 are unable to deform by widening, owing to centrifugal forces and/or thermal expansion, and maintain their ability to retain the rolling bodies 32 of the bearing unit 30.

Advantageously, referring again to FIG. 2, the inserts 44 are provided with an end edge 44b that strengthens the structure of the insert, facilitating the stop action it exerts on the fingers 43.

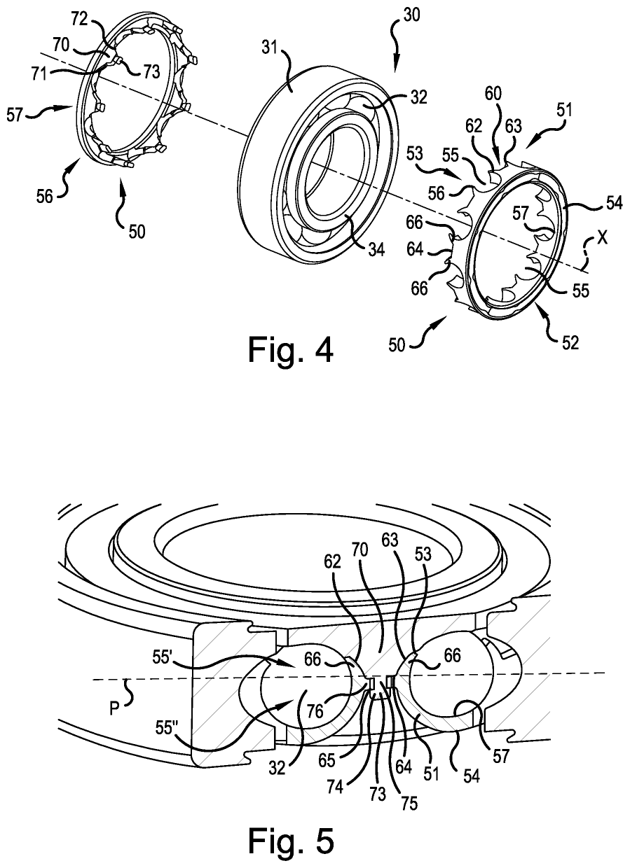

Referring to FIGS. 4 and 5, a second embodiment of the disclosure will now be described. The retention device 50 is made of polymer material and includes a cage 51 having a cylindrical body 52. The cage 51 has a first axial side 53 and a second axial side 54 and a plurality of pockets 55 that extend into the first axial side 53. Each of the plurality of pockets 55 extends radially through the cylindrical body 52 and has an axial opening 56 and a pocket bottom 57 axially spaced from the axial opening 56. Each of the pockets 55 retains a rolling body 32 that has a diameter greater than a circumferential width of the axial opening 56. A plurality of depressions 60 extend axially into the first axial side 53 of the cage 51 between each adjacent pair of the plurality of pockets 55, and each of the depressions 60 has a first side wall 62 and a second side wall 63 configured such that a circumferential distance between the first side wall 62 and the second side wall 63 decreases in a direction from the first axial side 53 toward the second axial side 54. Each of the depressions 60 includes a depression bottom 64 having an aperture 65, and the aperture 65 has a circumferential width. The retention device 50 also includes least one insert 70 formed separately from the cage 51.

An axially outer portion 55′ of each pocket 55 is defined by the first axial side 53 of the cage 51 and an imaginary plane P intersecting the depression bottoms 64, and an axially inner portion 55″ of each pocket 55 is located between the imaginary plane P and the second axial side 54 of the cage. Portions of the cage 51 located circumferentially between the axially outer portion 55′ of each pocket 55 and the depression form fingers 66 configured to flex to permit one of the rolling bodies 32 to move axially through the axial opening 56 when the at least one insert 70 is not located in any of the plurality of depressions 60.

The at least one insert 70 includes a first side wall 71 in contact with the first side wall 62 of the depression 60 at a first joint and a second side wall 72 in contact with the second side wall 63 of the depression 60 at a second joint and a projection 73 extending through the aperture 65 in the depression bottom 64. The projection 73 includes a distal end 74 and a neck 75 between the distal end 74 and the imaginary plane P. A circumferential width of the neck 75 is less than the circumferential width of the aperture 65 in the depression bottom 64 and the first side wall 71 of the insert 70 is in contact with the first side wall 62 of the depression 64 and the second side wall 72 of the insert 70 is in contact with the second side wall 63 of the depression 64. The at least one insert 70 is configured to prevent the fingers 66 from flexing to a degree that would permit the rolling body 52 in the pocket 55 adjacent to the at least one insert 70 from moving axially out of the axial opening 56. The neck 75 is aligned with a radial ridge 76 on the baring cage 51.

As in the preceding configuration, the pockets 55 have partially spherical concave surfaces for retaining respective balls 32 by way of contact zones.

Therefore the insert 70 has a suitable geometry that guarantees, once assembled, retention of the balls 32 by the cage 51.

Referring to FIG. 5, the method of assembly of this retention device 50 comprises assembly of the cage 51 and balls 32 in the bearing unit 30 and then assembling the insert 70 with the cage 51 by moving the inserts 70 into the depressions 60 until the first side walls 71 of the insert 70 contacts the first side walls 62 of the depressions 60 and the second side walls 72 of the insert 70 contacts the second side walls 63 of the depressions 60 and the projections 73 extend through the apertures 65 in the bottoms 64 of the depressions 60 until the necks 75 of the projections 73 are located between pairs of radial ridges 76 on the bearing cage 51. The projections 73 prevent the pairs of fingers 66 from separating if an axial force is applied against one of the balls to prevent the ball from exiting the pocket 55. The radial ridges 76 engage the necks 75 when pairs of the fingers 66 are biased away from each other, and this helps retain the insert 70 in contact with the cage 51.

Once coupled, the fingers 66 of the cage 51 are unable to deform by widening, owing to centrifugal forces and/or thermal expansion, and maintain their ability to retain the rolling bodies 32 of the bearing unit 30.

The inserts 70 may be formed as individual elements or they may be interconnected. An advantage of implementing this second configuration with a one-piece insert holder is that it creates greater rigidity for the structure of the whole retention device 50, more effectively preventing expansion and opening of the fingers 66 of the cage 51.

The operating principle of these retention devices, at high speed and at high temperature, is as follows: the cage is entrained by the rolling bodies and, in addition, the capacity for retention is increased by the presence of the inserts 70, mounted individually or by means of an insert holder, which block the fingers of the cage, preventing any widening thereof.

The retention device according to the disclosure, once mounted, does not run any risk of being pulled out of its seating, and offers greater rigidity for any speeds.

Preferably, the process of assembly of the retention device is facilitated if a snap-fitting solution is used for the coupling between the inserts and the finger seats of the cage.

Moreover, according to the present disclosure, the weight of the retention device is better distributed around the center of gravity of the rolling bodies compared to a conventional polymer cage without the disclosed inserts.

This retention device thus makes it possible to use the bearing unit in all applications requiring performance at high speed and/or at high temperature, avoiding the use, for these performance applications, of metal cages which, besides being more expensive, also become very noisy at high speed.

Theoretical and experimental findings have demonstrated that at 30000 rev/min the fingers of the socket cage “open” only by 0.24 mm, yet provide excellent retention of the rolling bodies, and the whole retention device remains in its assembly position even at high speed.

Moreover, operating at 30000 rev/min but also at high temperatures, for example at 150° C., the radial deformation of the cage is only 0.38 mm. The result is that the cage remains in position without rubbing on the radially outer ring even at high speeds and high temperatures.

Besides the embodiments of the invention described above, it has to be understood that there are numerous further variants. It must also be understood that these embodiments are only for purposes of illustration, and do not limit the scope of the invention, nor its applications, nor its possible configurations. Conversely, although the description given above makes it possible for a person skilled in the art to implement the present invention at least according to its exemplary configuration, it has to be understood that numerous variations of the components described are conceivable, without going beyond the scope of the invention, as defined in the appended claims, interpreted literally and/or according to legal equivalents thereof.

What is claimed is:

1. A bearing unit comprising:
a radially outer ring,
a radially inner ring,
a cage between the radially outer ring and the radially inner ring comprising a cylindrical body having a radially inner surface, a radially outer surface, a first axial side and a second axial side, and a plurality of pockets extending axially into the first axial side, each of the plurality of pockets extending radially through the cylindrical body and having an axial opening and a pocket bottom axially spaced from the axial opening, each of the pockets retaining a rolling body having a diameter greater than a circumferential width of the axial opening,
a plurality of depressions extending axially into the first axial side of the cage between each adjacent pair of the plurality of pockets, each of the depressions having a first side wall and a second side wall configured such that a circumferential distance between the first side wall and the second side wall decreases in a direction from the first axial side toward the second axial side and each of the depressions including a depression bottom having an aperture, the aperture having a circumferential width, and
at least one insert formed separately from the cage,
wherein an axially outer portion of each pocket is defined by the first axial side of the cage and an imaginary plane intersecting the bottoms of each of the depressions,
wherein an axially inner portion of each pocket is located between the imaginary plane and the second axial side of the cage,
wherein portions of the cage located circumferentially between the axially outer portion of each pocket and the depression form fingers configured to flex to permit one of the rolling bodies to move axially through the axial opening when the at least one insert is not located in the plurality of depressions,
wherein the at least one insert includes a first side wall in contact with the first side wall of the depression at a first joint and a second side wall in contact with the second side wall of the depression at a second joint and a projection extending through the aperture in the depression bottom,
wherein the projection includes a distal end and a neck between the distal end and the imaginary plane,
wherein a circumferential width of the neck is less than the circumferential width of the aperture in the depression bottom, and
wherein when the first side wall of the insert is in contact with the first side wall of the depression and the second side wall of the insert is in contact with the second side wall of the depression the at least one insert is configured to prevent the fingers from flexing to a degree that would permit the rolling body in the pocket adjacent to the at least one insert from moving axially out of the axial opening.

2. The bearing unit according to claim 1,
wherein a distal end portion of the projection has a circumferential width greater than the circumferential width of the neck.

3. The bearing unit according to claim 2,
wherein the circumferential width of the distal end portion is substantially equal to the circumferential width of the aperture in the depression bottom.

4. The bearing unit according to claim 2,
wherein the bearing cage includes a radial ridge aligned axially with the neck.

5. The bearing unit according to claim 4,
wherein an axial length of the neck is greater than an axial thickness of the ridge.

6. The bearing unit according to claim 5,
wherein the at least one insert comprises a plurality of inserts projecting axially from an annular support.

7. The bearing unit according to claim 1,
wherein the at least one insert comprises a plurality of inserts projecting axially from an annular support.

8. The bearing unit according to claim 7,
wherein a distal end portion of the projection has a circumferential width greater than the circumferential width of the neck.

9. The bearing unit according to claim 8,
wherein the bearing cage includes a radial ridge aligned axially with the neck.

10. The bearing unit according to claim 9,
wherein an axial length of the neck is greater than an axial thickness of the ridge.

11. The bearing unit according to claim 10,
wherein the circumferential width of the distal end portion is substantially equal to the circumferential width of the aperture in the depression bottom.
